(19) United States
(12) Patent Application Publication
(10) Pub. No.: US 2026/0018951 A1
(43) Pub. Date: Jan. 15, 2026

(54) Stator, Motor and Motor Actuator Using Stator

(71) Applicant: Tokyo Parts Industrial Co., Ltd., Gunma-ken (JP)

(72) Inventor: Hidekazu IMAI, Gunma-ken (JP)

(21) Appl. No.: 19/200,884

(22) Filed: May 7, 2025

(30) Foreign Application Priority Data
Jul. 9, 2024 (JP) 2024-110327

(51) Int. Cl. H02K 3/34; H02K 1/14; H02K 7/116

(52) U.S. Cl. CPC H02K 3/345; H02K 1/14; H02K 7/116

(57) ABSTRACT

A stator has a core, an insulating member covering the core, windings, wound around the insulating member, and conductive members, which supply drive power to the windings. The conductive members are inserted into insertion holes in the insulating member and are connected to coil ends. The insulating member is configured to be splittable such that a gap is formed at a split location. Auxiliary insulating means are provided at positions corresponding to the gap at at least one of the peripheries of the insertion holes and the conductive members.

### BACKGROUND OF THE INVENTION

The present invention relates, for example, to stators, motors, and motor actuators.

Conventionally, there are motors that comprise a stator and a rotor, which is rotated by a magnetic field produced by the stator. As an example of a stator in such a motor, Japanese Patent Laid-Open Publication No. 2022-023793 discloses a configuration in which, as shown in FIG. 13, conductive members 240, which relay power to windings 230, are inserted into penetration holes 223 provided in an insulating member 220, a winding end 231 is wound at one end of the conductive members 240, the other end of which extends downward from the insulating member 220 to serve as a board connection part 243. With such a configuration, the winding 230 and the circuit board can easily be connected.

Furthermore, by providing a joining part 241 in the conductive member 240 and receiving the joining part 241 in a receiving groove 224 in the bottom surface of the insulating member, the conductive member 240 will not unduly move, even if an axially upwardly oriented force is applied to the conductive member 240 (axial direction: up-down direction in FIG. 13). It is considered that highly reliable connections such as press fitting are thereby enabled.

In the stator 200 shown in Japanese Patent Laid-Open Publication No. 2022-023793, the core 210, which is a magnetic body, and the windings 230 are insulated by the insulating member 220. The insulating member 220 is configured to be splittable into a first core cover 221 and a second core cover 222. With such a configuration, a gap 225 is formed at a position corresponding to the split location. There was a problem that, if dust or the like accumulates in the gap 225 around the penetration holes 223, the insulation between the conductive members 240, which have been inserted into the penetration holes 223, and the core 210 is reduced.

### SUMMARY OF THE INVENTION

One or more examples of the present invention provide a stator that can prevent reductions in the insulation of the conductive members that have been inserted into the insulating member, even if dust or the like accumulates at the split location in the splittable insulating member.

In addition, motors and motor actuators employing a stator having the aforementioned feature are also provided.

Hereafter, aspects of the present invention directed to solving the problems described above are described. Note that, in the aspects described below, the constituent elements employed can be used in the most freely chosen combinations possible. Furthermore, the aspects and technical features of the present invention are not limited to those described hereafter, and are to be understood based on the description in the entire specification and the drawings, or based on the inventive ideas that can be grasped by the skilled artisan based on these descriptions.

One mode of embodiment of the stator of the present invention has
a core,
an insulating member covering the core,
a winding that is wound on the insulating member, and
a conductive member for supplying drive power to the winding,
wherein:
the insulating member is configured to be splittable at a split location;
the insulating member has a part allowing insertion for inserting the conductive member;
the conductive member is inserted into the part allowing insertion and is electrically connected to the winding; and
an auxiliary insulating means is provided at a position corresponding to the split location at at least one of the periphery of the part allowing insertion and the conductive member.

One mode of embodiment of the motor of the present invention is
a motor comprising a stator and a rotor, which is rotated by a magnetic field produced by the stator, wherein:
the stator has
a core,
an insulating member covering the core,
a winding that is wound on the insulating member, and
a conductive member for supplying drive power to the winding;
the insulating member is configured to be splittable at a split location;
the insulating member has a part allowing insertion for inserting the conductive member;
the conductive member is inserted into the part allowing insertion and is electrically connected to the winding; and
an auxiliary insulating means is provided at a position corresponding to the split location at at least one of the periphery of the part allowing insertion and the conductive member.

One mode of embodiment of the motor actuator of the present invention comprises:
a motor of the present invention as described above;
a gear mechanism, which transmits a rotational driving force of the motor while reducing the speed; and
an output shaft that outputs the rotational driving force to the outside.

Another mode of embodiment of the motor actuator of the present invention has
a stator,
a rotor, which is rotated by a magnetic field produced by the stator,
a gear mechanism, which transmits a rotational driving force of the rotor while reducing the speed,
an output shaft that outputs the rotational driving force to the outside, and
a case,
wherein:
the stator has
a core,
an insulating member covering the core,
a winding that is wound on the insulating member, and
a conductive member for supplying drive power to the winding;
the insulating member is configured to be splittable at a split location;
the insulating member has a part allowing insertion for inserting the conductive member;
the conductive member is inserted into the part allowing insertion and is electrically connected to the winding;
an auxiliary insulating means is provided at a position corresponding to the split location at at least one of the periphery of the part allowing insertion and the conductive member; and
the stator is fixed in a stator retaining part that is provided on the case.

According to the present invention, even if dust or the like accumulates at the split location in the insulating member, which is configured to be splittable, reductions in insulation between the conductive members and the core can be prevented.

### BRIEF DESCRIPTION OF THE DRAWINGS

FIGS. 1A and 1B show perspective views of a stator according to a first exemplary mode of embodiment of the present invention, in which FIG. 1A is a perspective view seen from above and FIG. 1B is a perspective view seen from below.

FIG. 2 is a configuration view of a stator according to a first exemplary mode of embodiment of the present invention.

FIG. 3 is a cross-sectional view at A-A in FIG. 2.

FIG. 4 is an enlarged cross-sectional view of portion IV in FIG. 3.

FIGS. 5A and 5B show perspective views of a core cover in a stator according to the first exemplary mode of embodiment of the present invention, in which FIG. 5A is a perspective view of the first core cover seen from below and FIG. 5B is a perspective view of the second core cover seen from above.

FIG. 6 is a cross-sectional view of a stator according to a second exemplary mode of embodiment of the present invention.

FIG. 7 is an enlarged cross-sectional view of portion VII in FIG. 6.

FIG. 8 is an enlarged cross-sectional view showing a variant of the stator according to the second exemplary mode of embodiment of the present invention.

FIGS. 9A, 9B and 9C show perspective views of a motor according to a third exemplary mode of embodiment of the present invention, in which FIG. 9A is an assembly view of a stator, FIG. 9B is a view immediately after the stator has been fixed, and FIG. 9C is a completion view.

FIGS. 10A and 10B show schematic views of a motor actuator according to a fourth exemplary mode of embodiment of the present invention, in which FIG. 10A is a view in which a worm gear is used and FIG. 10B is a view in which a pinion gear is used.

FIGS. 11A and 11B show schematic views of a motor actuator according to a fifth exemplary mode of embodiment of the present invention, in which FIG. 11A is an exterior view and FIG. 11B is a top view.

FIGS. 12A, 12B, and 12C show perspective views showing the assembly of a motor part of a motor actuator according to a fifth exemplary mode of embodiment of the present invention, in which FIG. 12A is an assembly view, FIG. 12B is a view immediately after the stator and the circuit board have been fixed, and FIG. 12C is a completion view.

FIG. 13 is a cross-sectional view describing the prior art.

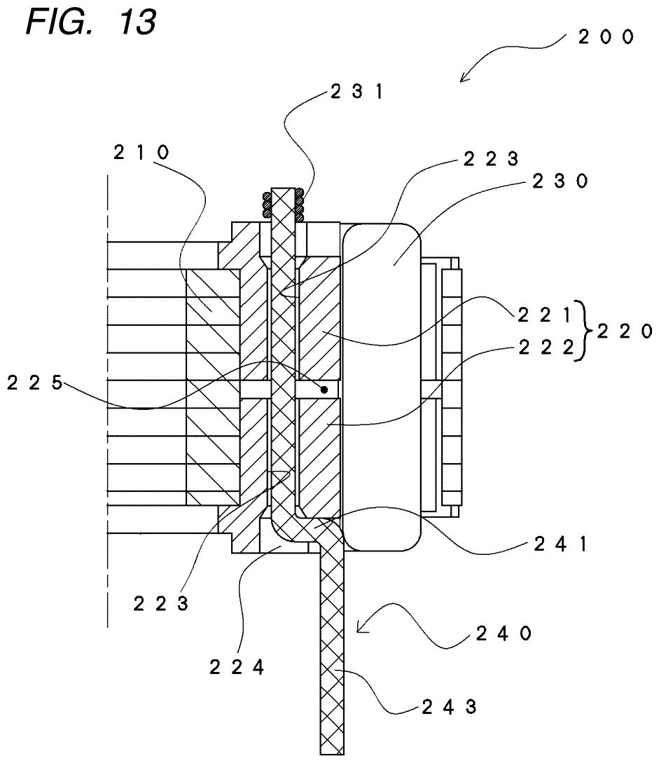

### DETAILED DESCRIPTION OF THE PREFERRED EMBODIMENTS

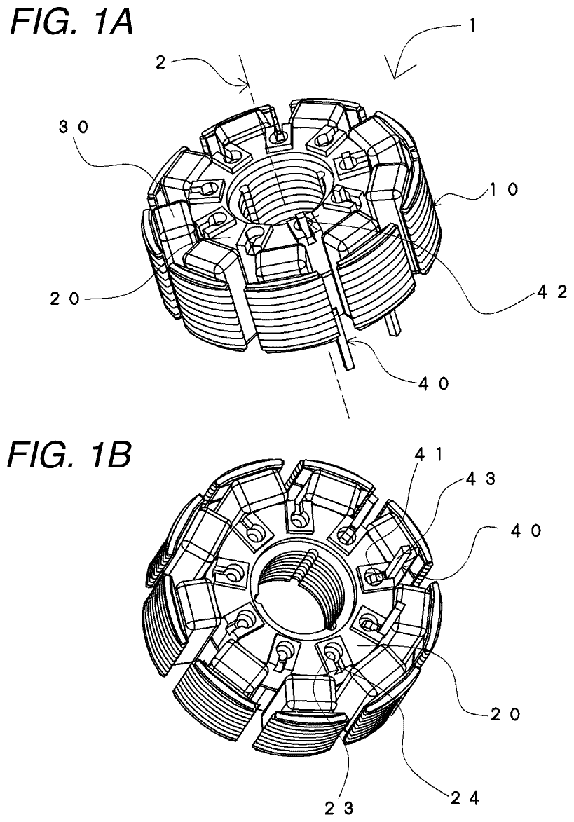

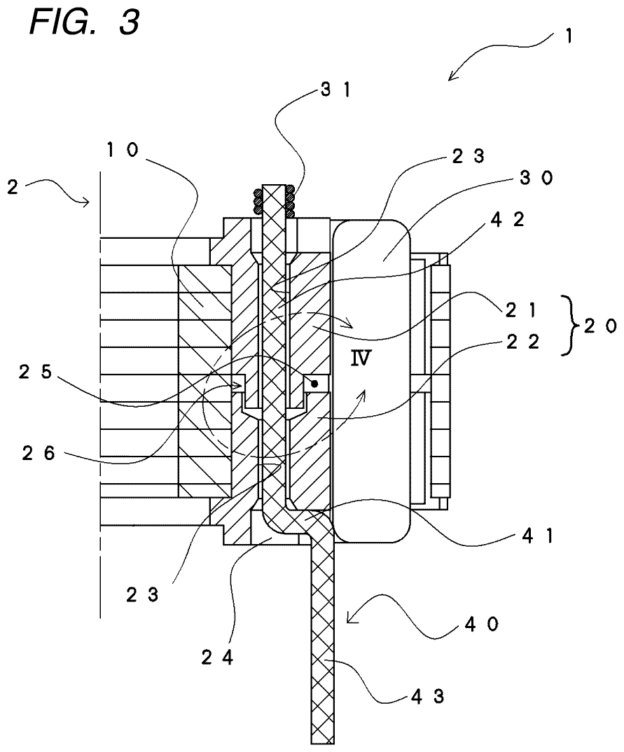

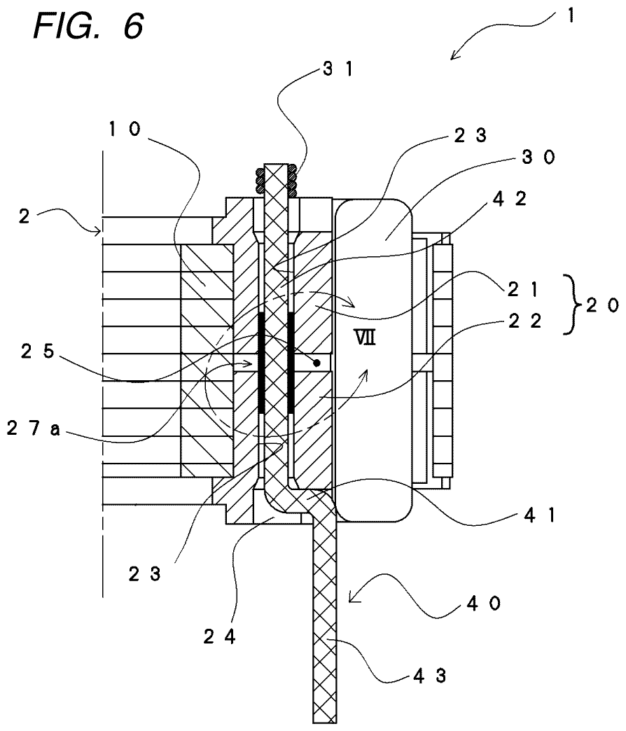

In the present specification, the direction parallel to the central axis in FIG. 1A, FIG. 1B, FIG. 3, FIG. 6, and the like is referred to as “axial”, the radial direction centered on the central axis is referred to as “radial”, and the circumferential direction centered on the central axis is referred to as “circumferential”. Also, the upward direction in FIG. 3, FIG. 6, and the like is referred to simply as “upward” and the downward direction therein is referred to simply as “downward”.

Note that upward and downward do not necessarily coincide with the positional relationships and directions when assembled in an actual device.

Hereafter modes of embodiment of the present invention are illustratively described based on the drawings.

### First Exemplary Mode of Embodiment

The stator in the first exemplary mode of embodiment of the present invention is described using FIGS. 1A-1B through FIG. 3. A stator 1 is a stator in a so-called outer rotor type brushless motor and has a core 10, an insulating member 20 covering the core 10, a plurality of windings 30 wound on the insulating member 20, and a plurality of conductive members 40 for supplying drive power to the windings 30.

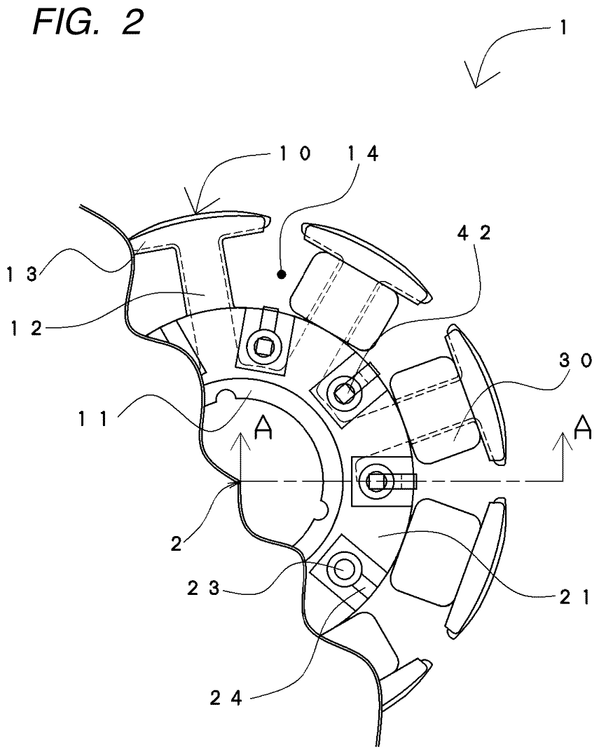

The core 10 is arranged around the central axis 2. The core 10 comprises a magnetic body and has an annular part 11 formed so as to surround the central axis 2, a plurality of pole teeth 12 extending radially outward from the annular part 11, and flange parts 13 extending circumferentially from the ends of the pole teeth 12. Slots 14 are formed between the pole teeth 12. Note that, to facilitate description, a winding 30 wound onto one of the pole teeth 12 is not shown in FIG. 2.

The insulating member 20 is molded from an insulating resin and is configured to be splittable, in the axial direction, into a first core cover 21, which is mounted from axially above the core 10, and a second core cover 22 which is mounted from axially below to the core 10. The insulating member 20 covers the upper and lower surfaces and outer peripheral surface of the annular part 11 of the core 10, the periphery of the pole teeth 12, and the inner peripheral surfaces of the flange parts 13, and ensures insulation between the core 10 and the windings 30 and the conductive members 40, which are described below.

In the present exemplary mode of embodiment, because there is no contact at the split location between the first core cover 21 and the second core cover 22, a gap 25 is formed at the split location between the first core cover 21 and the second core cover 22.

The insulating member 20 has insertion holes 23 for inserting an insertion part 42 of the conductive members 40, which are described below, in the axial direction. The insertion holes 23 are provided near the annular part 11, between the pole teeth 12, and these insertion holes 23 correspond to the part allowing insertion in the present exemplary mode of embodiment. Auxiliary insulating parts 26, which are described below, are formed at positions corresponding to the gap 25 around the insertion holes 23.

Furthermore, on the lower surface of the insulating member 20, receiving grooves 24 are formed from the open ends of the insertion holes 23 extending toward the outer side in the radial direction, for receiving the joining parts 41 of the conductive members 40 described below. In the present exemplary mode of embodiment, since the first core cover 21 and the second core cover 22 have generally the same shape, the insertion holes 23 and the receiving grooves 24 are provided in generally the same positions on both the first core cover 21 and the second core cover 22.

The conductive member 40 comprises: a joining part 41, which is provided extending in the radial direction substantially parallel to the receiving groove 24 that is provided in the insulating member 20, an insertion part 42 rising axially upward from one end (FIG. 3: left) of the joining part 41, and a board connection part 43 descending axially downward from the other end (FIG. 3: right) of the joining part 41.

The insertion part 42 of the conductive member 40 is inserted into the insertion hole 23 from below the insulating member 20 and is held so as to penetrate the insulating member 20. At that time, the tip of the insertion part 42 protrudes above the insulating member 20 and is electrically connected to the winding end 31 of the winding 30, which is described below. The joining part 41 of the conductive member 40 is received in a receiving groove 24 provided at the bottom of the insulating member 20, and contacts the bottom surface of the receiving groove 24 over substantially the entire region.

Windings 30 for generating magnetic fields are wound on the pole teeth 12, the peripheries of which are covered by the insulating member 20. The winding ends 31 are wound around the insertion parts 42 of the conductive members 40 and are electrically connected by any method, such as welding or soldering.

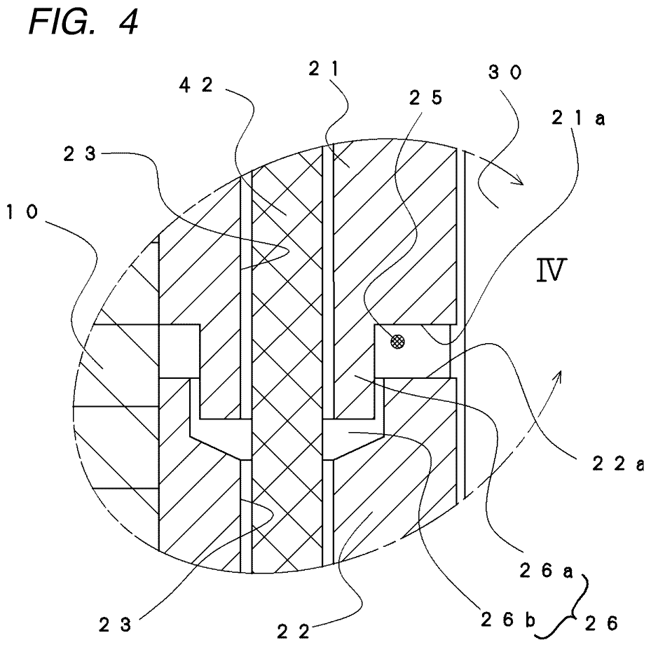

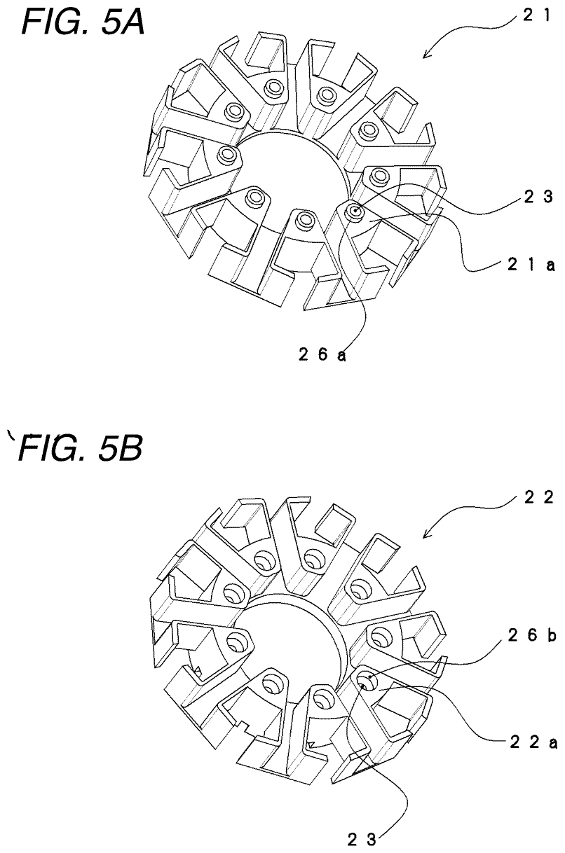

The auxiliary insulating part 26, which is the auxiliary insulating means in the present exemplary mode of embodiment, will be described using FIG. 4 and FIGS. 5A-5B. At the split location between the first core cover 21 and the second core cover 22, the split surface 21a of the first core cover and the split surface 22a of the second core cover face each other with the gap 25 therebetween.

A protrusion 26a is formed, around the insertion hole 23, on the split surface 21a of the first core cover, so as to surround the insertion hole 23 around the entire periphery thereof with the insertion hole 23 as the center. Furthermore, a recess 26b is formed, around the insertion hole 23, in the split surface 22a of the second core cover so as to surround the insertion hole 23 around the entire periphery thereof with the insertion hole 23 as the center. The axial length of the protrusion 26a is longer than the assumed axial length of the gap 25, and the protrusion 26a is formed in a shape that can be inserted into the recess 26b. Inserting the protrusion 26a into the recess 26b results in an auxiliary insulating part 26, which serves as the auxiliary insulating means in the present exemplary mode of embodiment.

By forming the auxiliary insulating part 26, insulation can be well maintained between the conductive member 40 and the core 10 and between the conductive member 40 and the winding 30, even if dust or the like accumulates in the gap 25 that is formed at the split location in the insulating member 20.

In the present exemplary mode of embodiment, the protrusion 26a is approximately the same shape as the recess 26b but has slightly smaller dimensions, and the auxiliary insulating part 26 is formed by inserting the protrusion 26a into the recess 26b, but there is no limitation to this. The protrusion 26a may be configured to have substantially the same shape as the recess 26b so that these fit together. The protrusion 26a may also be configured to be press-fitted in the recess 26b by giving it slightly larger dimensions.

In the present exemplary mode of embodiment, protrusions 26a are provided on the first core cover 21 and recesses 26b are provided in the second core cover 22, but this may be reversed. Furthermore, rather than a limitation to only the protrusions 26a or only the recesses 26b being arranged on either the first core cover 21 or the second core cover 22, the protrusions 26a and the recesses 26b may be arranged together. At this time, where a protrusion 26a is provided on the first core cover 21, a recess 26b is provided at a corresponding location in the second core cover 22, and where a recess 26b is provided in the first core cover 21, a protrusion 26a is provided at a corresponding location on the second core cover 22.

Furthermore, in the present exemplary mode of embodiment, the protrusion 26a is formed so as to surround the insertion hole 23 around the entire circumference thereof, but this may be limited to being formed only in a direction where there is a particular concern in terms of reduced insulation. As long as these are configured to enhance insulation of the conductive member 40 as a result of inserting the protrusions 26a into the recesses 26b, the arrangement, number, and shape of the protrusions 26a and the recesses 26b are not limited.

### Second Exemplary Mode of Embodiment

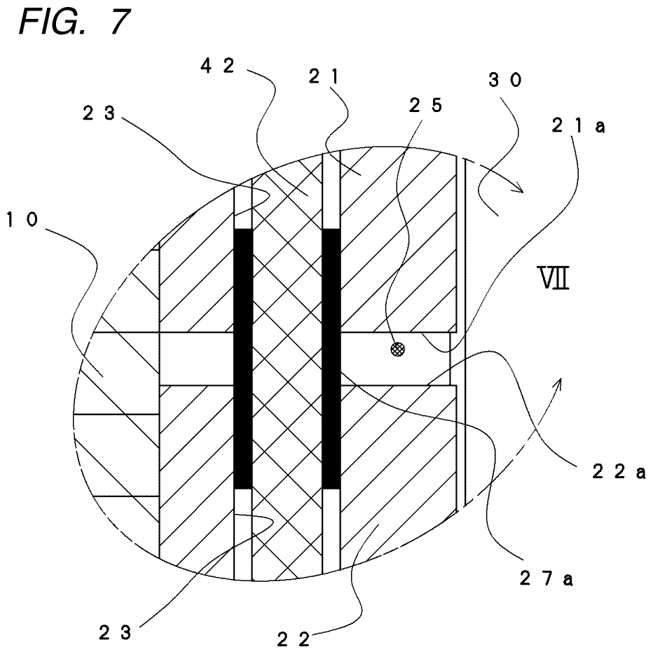

A stator according to a second exemplary mode of embodiment of the present invention will be described using FIG. 6 and FIG. 7. The stator 1 in the second exemplary mode of embodiment has a different auxiliary insulating means than in the first exemplary mode of embodiment. Because the configuration is otherwise the same as the stator 1 shown in the first exemplary mode of embodiment, reference will be made to FIG. 1A-1B to FIG. 3 as appropriate, the same components will be given the same reference numerals, and redundant descriptions will be omitted.

In the present exemplary mode of embodiment, the insertion parts 42 of the conductive members 40 are insulated by insulating coatings 27a. The insulating coating 27a is, for example, an insulating tube, and is provided on a portion of the insertion part 42 corresponding to the gap 25, covering the entire outer periphery of said portion. The insulating coating 27a corresponds to the auxiliary insulating means in the present exemplary mode of embodiment.

In addition to an insulating tube, the insulating coating 27a may be, for example, a resin tube made by resin molding, a resin film formed by applying an insulating coating agent, an insulating tape affixed to the outer periphery of the insertion part 42, or the like. Furthermore, although the insulating coating 27a is provided on a portion of the insertion part 42 corresponding to gap 25, there is no limitation to this portion alone, and it is also possible to cover a wider range, excluding the locations necessary for electrical connection with winding 30 and the circuit board (not shown). Furthermore, the insulating coating 27a can also be provided, not only on the outer periphery of the insertion part 42 but also on the inside of the insertion hole 23.

By forming the insulating coating 27a, insulation can be well maintained between the conductive member 40 and the core 10 and between the conductive member 40 and the winding 30, even if dust or the like accumulates in the gap 25 that is formed at the split location in the insulating member 20.

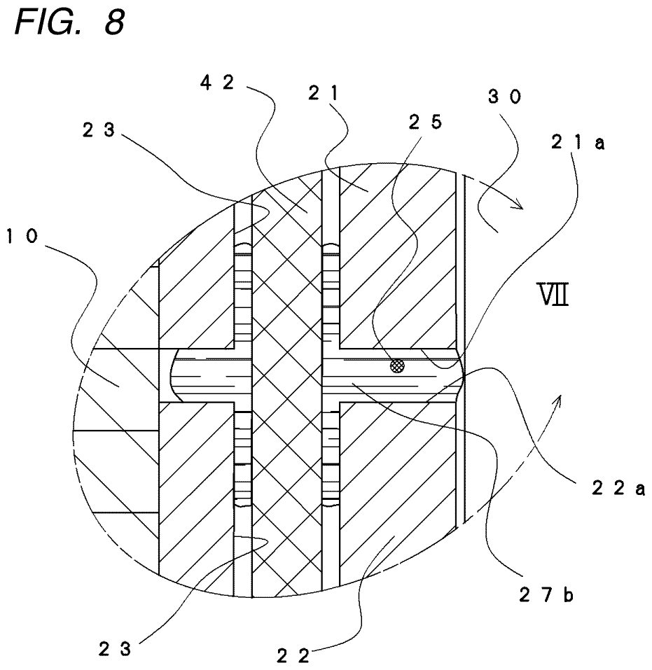

As a variation of the second exemplary mode of embodiment, a configuration in which the insertion hole 23 and the gap 25 are filled with a filling resin 27b is also possible, as shown in FIG. 8. Epoxy resins and the like, having excellent insulating properties, are preferred as the filling resin 27b. By preventing the accumulation of dust or the like in the gap 25, reductions in the insulation of the conductive member 40 are prevented, and the conductive member 40 can be firmly fixed in place by way of the adhesion of the filling resin 27b.

### Third Exemplary Mode of Embodiment

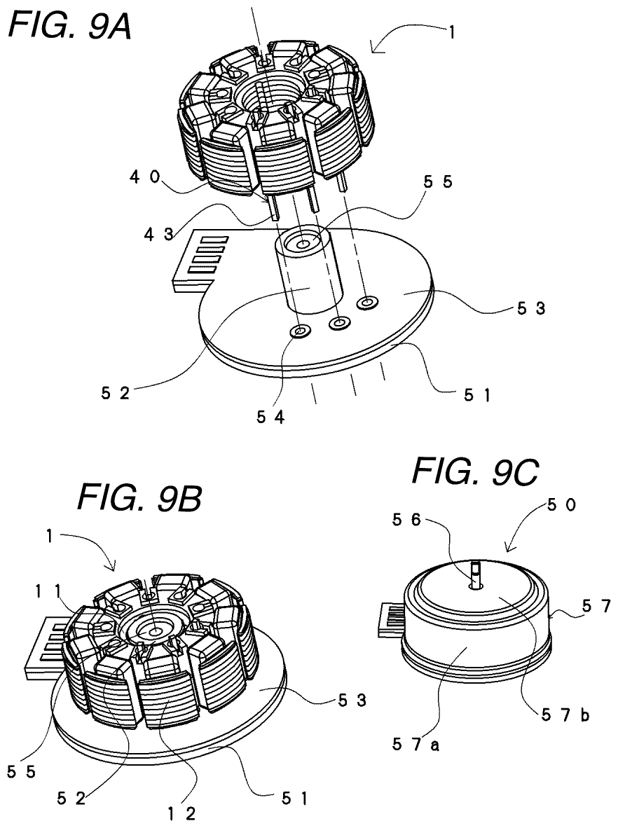

A motor according a third exemplary mode of embodiment of the present invention will be described using FIGS. 9A-9C. A motor 50 has a stator base 51, a bearing housing 52 and a circuit board 53 fixed on the stator base 51, a bearing 55 provided inside the bearing housing 52, a stator 1, and a rotor 57 having a shaft 56. Because the configuration of the stator 1 is the same as that of the stator 1 shown in the first exemplary mode of embodiment and the second exemplary mode of embodiment, for the configuration of the stator 1, reference will be made to FIGS. 1A-1B to FIG. 8, as appropriate, the same reference numerals will be applied to the same components, and redundant descriptions will be omitted.

The stator base 51 is made from of a thin sheet of metal, such as iron or aluminum, which is worked to a predetermined shape by pressing, and has a central hole in the vicinity of the center thereof. The bearing housing 52, which has a bottomed, substantially cylindrical shape, is fixed coaxially with the central hole. Inside the bearing housing 52, a bearing 55 made, for example, of an oil-impregnated sintered material, is fixed by way of any method.

The rotor 57 is formed in a lidded, substantially cylindrical shape and has a cylindrical part 57a and a substantially disc-shaped lid part 57b provided at the upper end of the cylindrical part 57a. The shaft 56 is press-fitted into the center of the lid part 57b so as to vertically penetrate therethrough. A drive magnet (not shown) is provided on the inner peripheral surface of the cylindrical part 57a, the drive magnet being arranged facing the pole teeth 12 of the core 10 in the stator 1, in the radial direction. The shaft 56 is supported by the bearing 55.

The circuit board 53 has a central hole and is fixed on the stator base 51 by way of any method, such as adhesion, so that the bearing housing 52 can be inserted through the central hole. A Hall element (not shown) is provided on the circuit board 53 as a means of detecting the position of the magnetic poles of the rotor 57. Furthermore, the circuit board 53 has through-holes 54 at positions corresponding to the board connection parts 43 of the conductive members 40 which are provided in the stator 1.

The stator 1 is inserted and fixed so that the inner peripheral surface of the annular part 11 of the core 10 contacts the outer peripheral surface of the bearing housing 52. The conductive members 40 are inserted into the through-holes 54 provided in the circuit board 53 and are electrically connected by way of any method, such as soldering.

When drive power is supplied to the conductive members 40 through the circuit board 53, magnetic fields are generated by way of the pole teeth 12 of the stator 1, and the rotor 57 rotates due to said fields. When the rotor 57 is rotated, an air current is generated inside the motor 50, and dust and the like enters into the motor 50 in conjunction therewith. However, with the motor 50 of the present exemplary mode of embodiment, auxiliary insulating means are provided at positions corresponding to the split location in the insulating member 20 (gap 25), and therefore reductions in insulation when dust or the like accumulates in the gap 25, and malfunctions of the motor due to the reductions in insulation can be prevented.

### Fourth Exemplary Mode of Embodiment

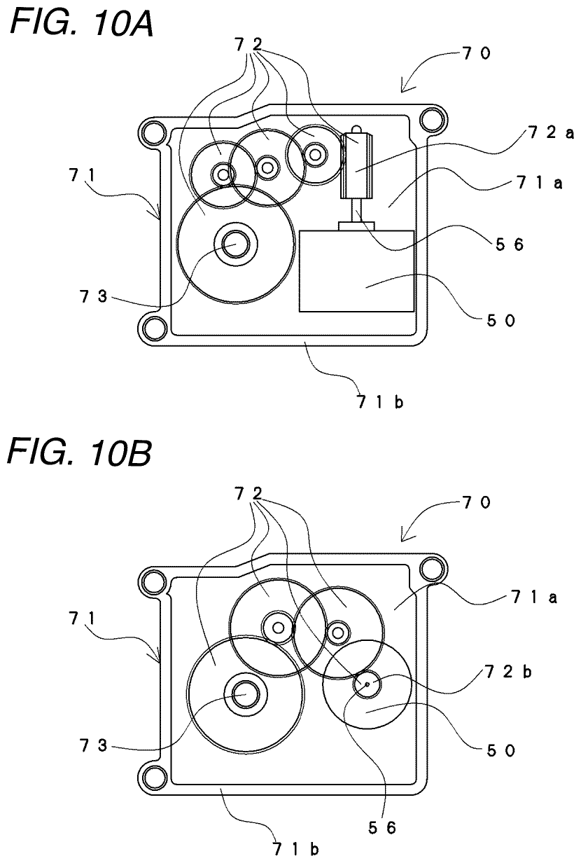

A motor actuator according to a fourth exemplary mode of embodiment of the present invention will be described using FIG. 10A. The motor actuator 70 has a lower case 71, an upper case (not shown), a motor 50, which serves as a drive source, a gear mechanism 72, which transmits a rotational driving force while reducing the speed, and an output shaft 73 that outputs the rotational driving force to the outside. Because the configuration of the motor 50 is the same as the motor 50 shown in the third exemplary mode of embodiment, for the configuration of the motor 50, reference will be made to FIGS. 9A-9C as appropriate, the same components will be given the same reference numerals, and redundant descriptions will be omitted.

The lower case 71 has a bottom wall 71a and four side walls 71b, and is in the shape of a substantially rectangular container, which is open on one side. A housing with a predetermined internal space is formed by assembling an upper case (not shown), which is also open on one side, with the opening sides meeting.

The bottom wall 71a of the lower case 71 is provided with a receiving part (not shown) for the motor 50, and the motor 50 is arranged so that the shaft 56 of the motor 50 is in a direction orthogonal to an output shaft 73, described below.

The rotational driving force of the motor 50 is transmitted to the output shaft 73 through a gear mechanism 72 including a worm gear 72a. A crank or the like, not shown in the figure, is attached to this output shaft 73.

By configuring the motor 50 and motor actuator 70 as described above, a highly reliable motor actuator can be realized, which prevents reductions in the insulation of the conductive members 40 in the stator 1, and which is suitable for automotive motor actuators and the like, which require particularly high reliability.

As shown in FIG. 10B, it is also possible to use a configuration in which a pinion gear 72b is attached to the shaft 56 and the motor 50 is arranged so that the shaft 56 and output shaft 73 of the motor 50 are parallel.

### Fifth Exemplary Mode of Embodiment

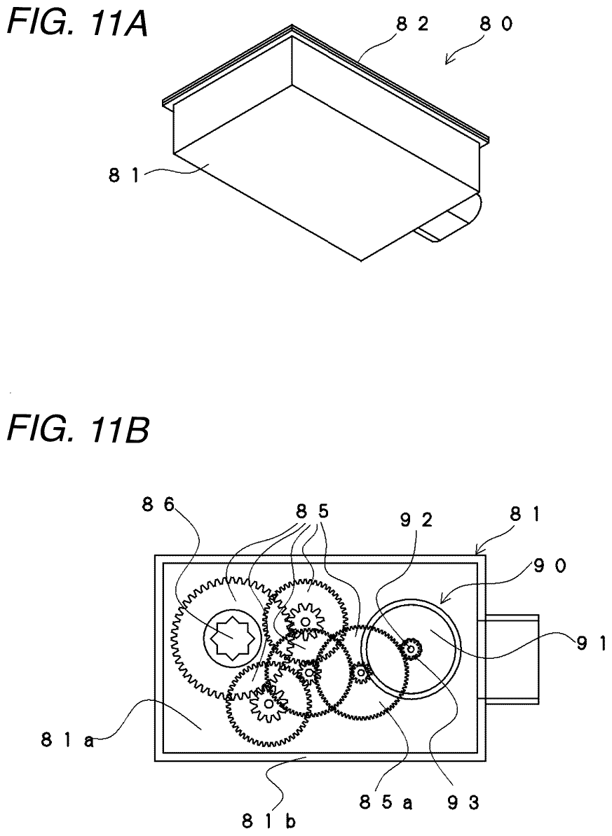

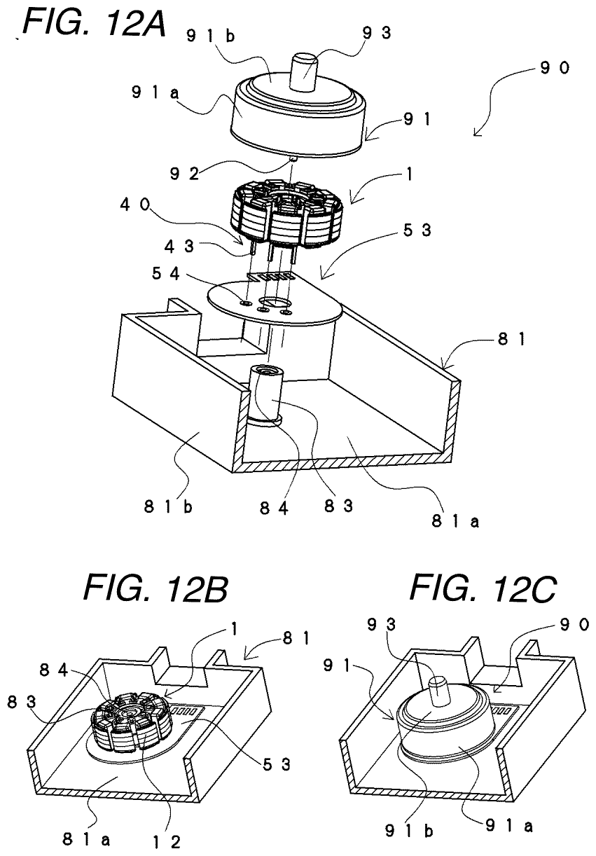

The motor actuator according to the fifth exemplary mode of embodiment of the present invention will be described using FIGS. 11A-11B and FIGS. 12A-12C. The motor actuator 80 of the present exemplary mode of embodiment can be used, for example, as a drive source for a vehicle grille shutter device, and principally has a lower case 81, an upper case 82, a motor 90, which is built into the lower case 81 and serves as a drive source, a gear mechanism 85, which transmits rotational driving force while reducing the speed, and an output shaft 86, which outputs the rotational driving force to the outside.

The motor 90 is a so-called outer rotor type motor, and the configurations of the stator 1 and the circuit board 53 are the same as shown in the first exemplary mode of embodiment to the third exemplary mode of embodiment. Therefore, for the configuration of the stator 1 and the circuit board 53 in the motor 90, reference will be made to FIGS. 1A-1B to FIG. 9A-9C as appropriate, the same components will be given the same reference numerals, and redundant descriptions will be omitted.

The lower case 81 has a bottom wall 81a and four side walls 81b, and is in the shape of a substantially rectangular container, which is open on one side. A housing with a predetermined internal space is formed by assembling the upper case 82 with the opening sides meeting. The upper case 82 is provided with an opening (not shown) to expose the output shaft 86 described below to the outside of the upper case.

A substantially cylindrical stator retaining part 83 is formed on the bottom wall 81a of the lower case 81 for fixing the stator 1 of the motor 90. A bearing 84 made of, for example, an oil-impregnated sintered material, is fixed inside the cylindrical part of the stator retaining part 83 by way of any method, such as press fitting. The circuit board 53 is fixed so that the central hole fits on the stator retaining part 83. Note that, in FIGS. 12A to 12C, in order to facilitate description, the illustration is limited to the area around the motor 90, and illustration of the gear mechanism 85 and the like is omitted.

The rotor 91 is formed in a lidded, substantially cylindrical shape and has a cylindrical part 91a and a substantially disc-shaped lid part 91b provided at the upper end of the cylindrical part 91a. A shaft 92 is fixed in the center of the lid part 91b by press fitting. A drive magnet (not shown) is provided on the inner peripheral surface of the cylindrical part 91a, the drive magnet being arranged facing the pole teeth 12 of the core 10 in the stator 1, in the radial direction. The shaft 92 is supported by the bearing 84. Furthermore, a pinion gear 93 is provided coaxially with the shaft 92 above the lid part 91b and meshes with a first-stage gear 85a of the gear mechanism 85.

The stator 1 is inserted and fixed so that the inner peripheral surface of the annular part 11 of the core 10 touches the outer peripheral surface of the stator retaining part 83. The board connection parts 43 of the conductive members 40 are inserted into through-holes 54 provided in the circuit board 53 and electrically connected by any method. When drive power is supplied to the conductive member 40 through the circuit board 53, magnetic fields are generated from the pole teeth 12 of the stator 1, with respect to a drive magnet (not shown), such that rotational driving force is generated in the rotor 91. The rotational driving force generated in the rotor 91 is transmitted from the pinion gear 93 to the gear mechanism 85 and output to the outside via the output shaft 86.

By configuring the motor 90 and motor actuator 80 as described above, a highly reliable motor actuator can be realized, which prevents reductions in the insulation of the conductive members 40 in the stator 1, and which is suitable for automotive motor actuators and the like, which require particularly high reliability.

Exemplary modes of embodiment of the present invention have been described above, but the present invention is not limited to that discussed above, and various modifications other than those discussed above can be made within a scope that does not depart from the gist thereof.

For example, in the exemplary modes of embodiment of the present invention, configurations in which the stator 1, the motor 50, and the motor 90 are of the outer rotor-type are described, but there is no limitation to this, and an inner rotor-type configuration is also possible. Furthermore, although a radial gap type motor is described, the present invention can, of course, also be applied to an axial gap type motor. In addition, the present invention can likewise be applied if the core is covered with a splittable insulating member and a stator is provided configured so that conductive members are inserted into the insulating member.

In the exemplary modes of embodiment of the present invention, the insertion holes 23 are arranged near the annular part 11 between the pole teeth 12, but there is no limitation to this. The insertion holes 23 can be arranged, for example, near the tips of the pole teeth, near the tips of the flanges, or the like.

In the exemplary modes of embodiment of the present invention, for the insulating member 20, a first core cover 21 and a second core cover 22, which have substantially the same shape, are combined in a splittable manner, but there is no limitation to this. The insulating member 20 may be configured such that, for example, a first core cover has a case shape and a second core cover has a lid shape and these are combined in a splittable manner.

In the exemplary modes of embodiment of the present invention, the configuration was such that there is a gap at the split location between the split surface 21a of the first core cover and the split surface 22a of the second core cover, but there is no limitation to this. The configuration may be such that the split surface 21a of the first core cover and the split surface 22a of the second core cover contact each other.

In the exemplary modes of embodiment of the present invention, the configuration is such that the insertion part 42 of the conductive member 40 penetrates through the insertion holes 23, but it is also possible that this does not penetrate therethrough. The conductive member 40 may also have a linear shape (so-called pin shape) without a bent portion midway.

Furthermore, the exemplary modes of embodiment of the present invention describe cases in which the stator 1 is used in the motor 50 and the motor actuator 80 into which the motor 90 has been incorporated, but there is no limitation to this. The stator in the present invention can also be applied to other known motors and motor actuators such as induction motors, synchronous motors, stepper motors, and reluctance motors.

What is claimed is:

1. A stator, comprising:
a core;
an insulating member covering the core;
a winding that is wound on the insulating member; and
a conductive member for supplying drive power to the winding;
wherein
the insulating member is configured to be splittable at a split location;
the insulating member has a part allowing insertion for inserting the conductive member;
the conductive member is inserted into the part allowing insertion and is electrically connected to the winding; and
an auxiliary insulating means is provided at a position corresponding to the split location at at least one of the periphery of the part allowing insertion and the conductive member.

2. The stator according to claim 1, wherein
the insulating member comprises:
a first core cover mounted from one axial direction of the core, and
a second core cover mounted from the other axial direction of the core;
and the auxiliary insulating means is an auxiliary insulating part provided at a position corresponding to the split location between the first core cover and the second core cover.

3. The stator according to claim 2, wherein
a protrusion is formed on one of the first core cover or the second core cover;
a recess is formed on the other of the first core cover or the second core cover; and
the auxiliary insulating part is formed by inserting the protrusion into the recess.

4. The stator according to claim 3, wherein
the protrusion and the recess surround the entire circumference of the part allowing insertion.

5. The stator according to claim 1, wherein
the auxiliary insulating means is an insulating coating provided on at least one of the conductive member and the inside of the part allowing insertion.

6. The stator according to claim 1, wherein
the auxiliary insulating means is a filling resin provided inside the part allowing insertion.

7. A motor comprising a stator and a rotor, which is rotated by a magnetic field produced by the stator, wherein
the stator comprises:
a core;
an insulating member covering the core;
a winding that is wound on the insulating member; and
a conductive member for supplying drive power to the winding;
the insulating member is configured to be splittable at a split location;
the insulating member has a part allowing insertion for inserting the conductive member;
the conductive member is inserted into the part allowing insertion and is electrically connected to the winding; and
an auxiliary insulating means is provided at a position corresponding to the split location at at least one of the periphery of the part allowing insertion and the conductive member.

8. The motor according to claim 7, wherein
the insulating member comprises:
a first core cover mounted from one axial direction of the core, and
a second core cover mounted from the other axial direction of the core; and
the auxiliary insulating means is an auxiliary insulating part provided at a position corresponding to the split location between the first core cover and the second core cover.

9. The motor according to claim 8, wherein
a protrusion is formed on one of the first core cover or the second core cover;
a recess is formed on the other of the first core cover or the second core cover; and
the auxiliary insulating part is formed by inserting the protrusion into the recess.

10. The motor according to claim 9, wherein
the protrusion and the recess surround the entire circumference of the part allowing insertion.

11. The motor according to claim 7, wherein
the auxiliary insulating means is an insulating coating provided on at least one of the conductive member and the inside of the part allowing insertion.

12. The motor according to claim 7, wherein
the auxiliary insulating means is a filling resin provided inside the part allowing insertion.

13. A motor actuator, comprising:
the motor according to claim 7;
a gear mechanism, which transmits a rotational driving force of the motor while reducing the speed; and
an output shaft that outputs the rotational driving force to the outside.

14. A motor actuator, comprising:
a stator;
a rotor, which is rotated by a magnetic field produced by the stator; and
a gear mechanism, which transmits a rotational driving force of the rotor while reducing the speed;
an output shaft that outputs the rotational driving force to the outside; and
a case;
wherein
the stator comprises:
a core;
an insulating member covering the core;
a winding that is wound on the insulating member; and
a conductive member for supplying drive power to the winding;
the insulating member is configured to be splittable at a split location;
the insulating member has a part allowing insertion for inserting the conductive member;
the conductive member is inserted into the part allowing insertion and is electrically connected to the winding;
an auxiliary insulating means is provided at a position corresponding to the split location at at least one of the periphery of the part allowing insertion and the conductive member, and
the stator is fixed in a stator retaining part that is provided on the case.

15. The motor actuator according to claim 14, wherein
the insulating member comprises:
a first core cover mounted from one axial direction of the core; and
a second core cover mounted from the other axial direction of the core; and
the auxiliary insulating means is an auxiliary insulating part provided at a position corresponding to the split location between the first core cover and the second core cover.

16. The motor actuator according to claim 15, wherein
a protrusion is formed on one of the first core cover or the second core cover;
a recess is formed on the other of the first core cover or the second core cover; and
the auxiliary insulating part is formed by inserting the protrusion into the recess.

17. The motor actuator according to claim 16, wherein
the protrusion and the recess surround the entire circumference of the part allowing insertion.

18. The motor actuator according to claim 14, wherein
the auxiliary insulating means is an insulating coating provided on at least one of the conductive member and the inside of the part allowing insertion.

19. The motor actuator according to claim 14, wherein
the auxiliary insulating means is a filling resin provided inside the part allowing insertion.
